(19) United States
(12) Patent Application Publication
(10) Pub. No.: US 2012/0274390 A1
(43) Pub. Date: Nov. 1, 2012

(54) POWER SUPPLY CIRCUIT

(75) Inventors: GUO-YI CHEN, Shenzhen City (CN); WEN-SEN HU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/174,694

(22) Filed: Jun. 30, 2011

(30) Foreign Application Priority Data
Apr. 26, 2011 (CN) 201110105035.8

(51) Int. Cl. G05F 3/08

(52) U.S. Cl. 327/519

(57) ABSTRACT

The power supply circuit which includes a first power circuit, a second power circuit, and a third power circuit is used for supplying power to loads. The first power circuit is connected between a control terminal of a control circuit and the load, and includes a switching unit including a first terminal, a second terminal, and a switching terminal controlling connection and disconnection between the first terminal and the second terminal The first terminal is connected to a power source, the second terminal is connected to the load, and the switching terminal is connected to the control terminal. The second power circuit and the third power circuit further includes a delay circuit relative to the first power circuit, the delay circuit is connected between the control terminal and the switching terminal, a delay time of the third power circuit is greater than the delay time of the second power circuit.

### BACKGROUND

1. Technical Field

The present disclosure relates to electronic circuits, and particularly, to a power supply circuit.

2. Description of Related Art

Power supply circuits generally supply power to a number of loads. A number of electrical elements compose each power supply circuit. A current spike will be generated in the power supply circuit when the loads are powered on at the same time. The current spike may damage the electrical elements. Furthermore, an external power source that supplies power to the power supply circuits will generate a voltage fluctuation under the influence of the current spike. The power grid may be damaged by the voltage fluctuation.

Therefore, it is desirable to provide a power supply circuit which can overcome the limitations described above.

### BRIEF DESCRIPTION OF THE DRAWING

FIG. 1 is a block diagram of a power supply circuit, according to an exemplary embodiment.

FIG. 2 is a circuit diagram of one embodiment of a delay circuit of the power supply circuit of FIG. 1.

### DETAILED DESCRIPTION

Exemplary embodiments of the disclosure will be described in detail, with reference to the accompanying drawings.

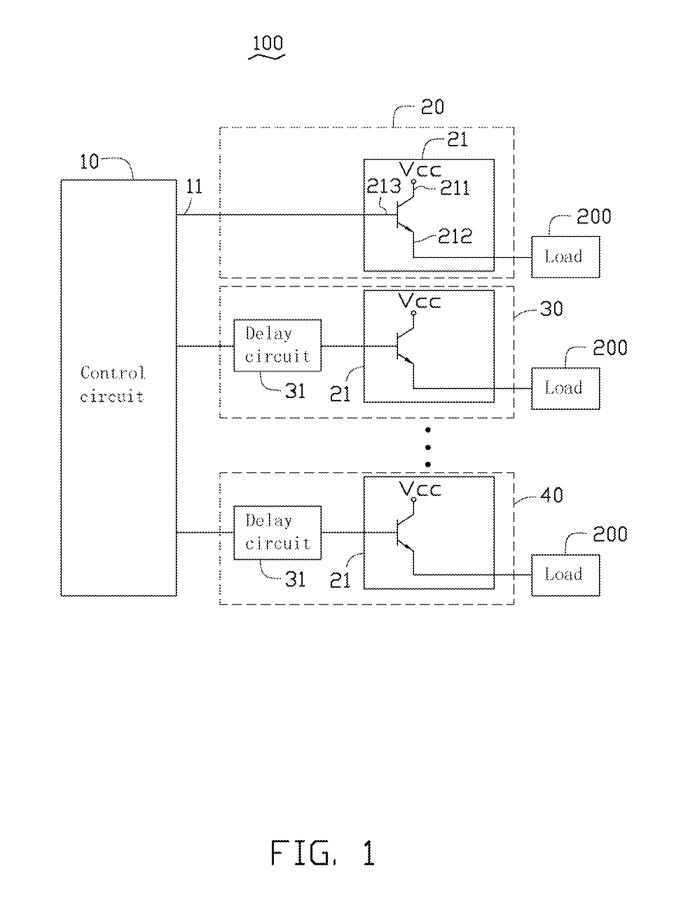

FIG. 1 is a block diagram of a power supply circuit 100, according to an exemplary embodiment. The power supply circuit 100 can supply power to a number of loads 200. The power supply circuit 100 includes a control circuit 10, a first power circuit 20, a second power circuit 30, and a third power circuit 40.

The control circuit 10 is a microcontroller (MCU), and includes a number of control terminals 11. The control circuit 10 outputs control signals from the control terminals 11. The control signals are high level signals, such as, +5V.

The first power circuit 20 includes a switching unit 21. The switching unit 21 includes a first terminal 211, a second terminal 212, and a switching terminal 213 controlling connection and disconnection between the first terminal 211 and the second terminal 212. The first terminal 211 is connected to a power source Vcc, the second terminal 212 is connected to the load 200, and the switching terminal 213 is connected to the control terminal 11. In this embodiment, the switching unit 21 is an npn type BJT, the first terminal 211 is a collector, the second terminal 212 is an emitter, and the switching terminal 213 is a base of the BJT.

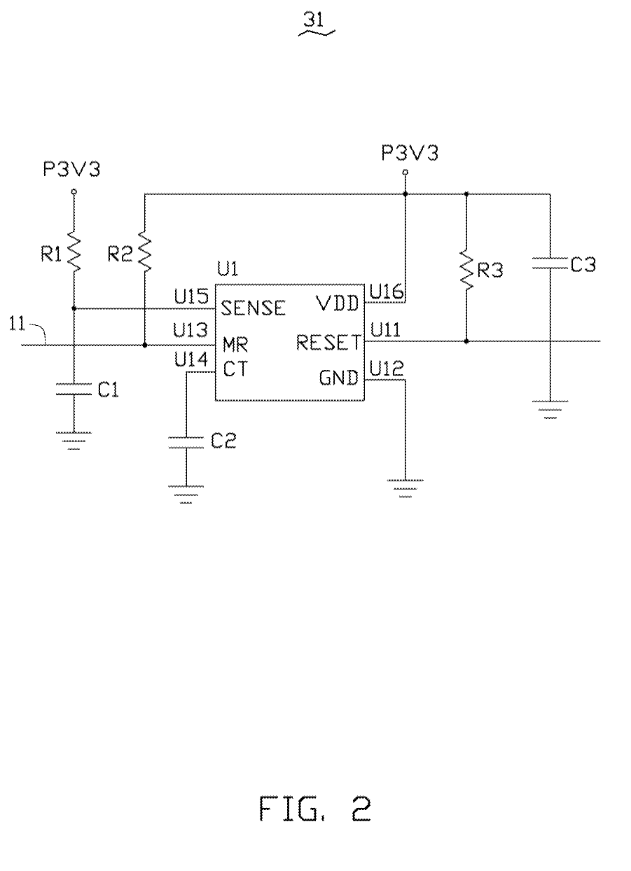

Further referring to FIG. 2, the second power circuit 30 and the third power circuit 40 each comprise the switching unit 21 and a delay circuit 31. The delay circuit 31 is connected between the control terminal 11 and the switching terminal 213 of the switching unit 21. The delay circuit 31 includes a delay integrated circuit (IC) U1, a first resistor R1, a first capacitor C1, a second capacitor C2, a second resistor R2, a third resistor R3, and a third capacitor C3.

The delay IC U1 and includes a RESET terminal U11, a GND terminal U12, a MR terminal U13, a CT terminal U14, a SENSE terminal U15, and a VDD terminal U16. The MR terminal U13 is connected to the control terminal 11 and configured for receiving the control signal output from the control circuit 10. The RESET terminal U11 is connected to the switching terminal 213 of the switching unit 21 and configured for outputting the control signal to the switching terminal 213. The GND terminal U12 is grounded. The CT terminal U14 is grounded via the second capacitor C2 and configured for charging the second capacitor C2. The SENSE terminal U15 is configured for providing a reference voltage. The VDD terminal U16 is connected to a voltage source P3V3. The first resistor R1 is connected between the voltage source P3V3 and the SENSE terminal U15. The first capacitor C1 is connected between the SENSE terminal U15 and grounded. The second resistor R2 is connected between the MR terminal U13 and the VDD terminal U16. The third resistor R3 is connected between the RESET terminal U11 and the VDD terminal U16. The third capacitor C3 is connected between the VDD terminal U16 and grounded.

The delay circuit 31 has a delay time, and the delay time is adjusted by changing the capacitance of the second capacitor C2. When the MR terminal U13 receives the control signal, the delay IC U1 charges the second capacitor C2. As the voltage value of the CT terminal U14 is higher than the reference voltage of the SENSE terminal U15, the MR terminal U13 connects to the RESET terminal U11. The control signal is output from the RESET terminal U11.

The capacitance of the second capacitor C2 of third power circuit 40 is greater than the capacitance of the second capacitor C2 of the second power circuit 30. The delay time of the delay circuit 31 of the third power circuit 40 is greater than the delay time of the delay circuit 31 of the second power circuit 30.

It should to be understood, the power supply circuit 100 further comprises a fourth power circuit, and a fifth power circuit. The delay time of the fourth power circuit is greater than the third power circuit, and the delay time of the fifth power circuit is greater than the fourth power circuit.

In use, the control circuit 10 outputs the control signals from the control terminals 11 at the same time. The switching unit 21 of the first power circuit 20 is turned on by the control signal, the first terminal 211 and the second terminal 212 is connected. The power source Vcc supplies power to the load 200 connected to the first power circuit 20. When the MR terminal U13 of the delay IC U1 of the second power circuit 30 receives the control signal, the second capacitor C2 is charged by the delay IC U1. As the voltage value of the CT terminal U14 is higher than that of the SENSE terminal U15, the MR terminal U13 connects to the RESET terminal U11, and the control signal is output to the switching unit 21 from the RESET terminal U11. The switching unit 21 of the second power circuit 30 is turned on by the control signal, the first terminal 211 and the second terminal 212 is connected. The power source Vcc supplies power to the load 200 connected to the second power circuit 30. Likewise, the power source Vcc supplies power to the load 200 connected to the third power circuit 40 after a delay time which is greater than the delay time of the second power circuit 30.

The second power circuit 30 and the third power circuit 40 each includes the delay circuit 31, and the delay time of the delay circuit 31 of the third power circuit 40 is greater than the delay time of the delay circuit 31 of the second power circuit 30.

Therefore, the loads 200 connected to the power circuits are powered on at a different time, a current spike will not be generated in the power supply circuit 100.

It will be understood that particular exemplary embodiments are shown and described by way of illustration only. The principles and the features of the present disclosure may be employed in various and numerous exemplary embodiments thereof without departing from the scope of the disclosure as claimed. The above-described exemplary embodiments illustrate the scope of the disclosure but do not restrict the scope of the disclosure.

What is claimed is:

1. A power supply circuit for a load, comprising:
a first power circuit connected between a control terminal of a control circuit and the load, and comprising a switching unit, the switching unit comprising a first terminal, a second terminal, and a switching terminal controlling connection and disconnection between the first terminal and the second terminal, the first terminal connected to a power source, the second terminal connected to the load, and the switching terminal connected to the control terminal; and
a second power circuit and a third power circuit each further comprising a delay circuit and the switching unit, the delay circuit connected between the control terminal and the switching terminal, a delay time of the third power circuit being greater than a delay time of the second power circuit.

2. The power supply circuit in claim 1, wherein the delay circuit comprises a delay integrated circuit (IC), a first resistor, a first capacitor, and a second capacitor; the delay IC comprises a RESET terminal, a GND terminal, a MR terminal, a CT terminal, a SENSE terminal, and a VDD terminal; the MR terminal is connected to the control terminal and receives the control signal from the control terminal, the RESET terminal is connected to the switching terminal of the switching unit and outputs the control signal to the switching terminal, the CT terminal is grounded via the second capacitor and charges the second capacitor, the VDD terminal is connected to a voltage source, the GND terminal is grounded, the SENSE terminal is configured for providing a reference voltage, the first resistor is connected between the voltage source and the SENSE terminal; the first capacitor is connected between the SENSE terminal and ground.

3. The power supply circuit in claim 2, wherein when the voltage value of the CT terminal is higher than the reference voltage of the SENSE terminal; the MR terminal connects to the RESET terminal, and the control signal outputs from the RESET terminal.

4. The power supply circuit in claim 2, wherein the delay circuit further comprises a second resistor, a third resistor, and a third capacitor; the second resistor is connected between the MR terminal and the VDD terminal; the third resistor is connected between the RESET terminal and the VDD terminal; the third capacitor is connected between the VDD terminal and ground.

5. The power supply circuit in claim 2, wherein the capacitance of the second capacitor of third power circuit is greater than the capacitance of the second capacitor of the second power circuit.

6. The power supply circuit in claim 1, wherein the switching unit is an npn type BJT, the first terminal is a collector, the second terminal is an emitter, and the third terminal is a base of the BJT.
